(19) United States
(12) Patent Application Publication
(10) Pub. No.: US 2023/0103688 A1
(43) Pub. Date: Apr. 6, 2023

(54) Composition, System and Process for Removing Oil Products from Asphalt Shingles

(71) Applicant: Vance Endicott, Avilla, MO (US)

(72) Inventor: Vance Endicott, Avilla, MO (US)

(21) Appl. No.: 17/492,998

(22) Filed: Oct. 4, 2021

(51) Int. Cl. B09B 3/00; C04B 41/00; B01D 17/02; B01D 21/02

(52) U.S. Cl. CPC B09B 3/0058; C04B 41/0009; B09B 3/0083; B01D 17/0214; B01D 21/02

(57) ABSTRACT

The present invention relates to a novel chemical composition for removing oil from asphalt shingles. The composition preferably comprises approximately 48% water, 48% fuel such as gasoline or diesel, 2% alcohol, 1.5% citrus and 0.5% enzyme by weight. The composition is used in a system comprising a plurality of tanks that operate under a controlled heat and pressure to breakdown oil components within the shingles. The system uses a closed loop process to feed back the residual ingredients of the composition for reuse. Once through the system, the oil is removed from the asphalt shingles, thereby preventing oil from leeching into the groundwater when the asphalt shingles are disposed of.

### FIELD OF THE INVENTION

The present invention relates generally to the field of chemicals. More specifically, the present invention relates to an oil extracting chemical designed to break down asphalt shingles and remove oil products, fiberglass and granules from the asphalt shingles to allow the shingles to be safely disposed of. The oil extracting chemical prevents the oil in the shingles from leeching into groundwater near landfills, and protects the environment from the harmful effects of asphalt shingle disposal. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, roofing shingles are often used in constructing buildings to increase the longevity of various structures. The standard roofing shingle not only provides protection to buildings, but also enhance the aesthetic appeal of buildings in urban and rural areas. There are various kinds of roofing shingles available in the market, such as asphalt shingles, fiberglass shingles, organic shingles, solar reflective shingles, etc. Among these construction shingles, the most popular roofing material is asphalt roof shingles which are used on homes across North America and in other parts of the world. Asphalt roof shingles protect a building/structure through decades of weathering with minimal upkeep, and are available in hundreds of colors and styles. Additionally, asphalt roof shingles have a long lifespan and are relatively inexpensive.

After use, asphalt shingles are often torn off a structure/building and discarded. Typically, the asphalt shingles are disposed of in a landfill. However, asphalt is a by-product of refining crude oil and, therefore, oil is the primary ingredient in asphalt shingles. Thus, when asphalt shingles are disposed of in a landfill, the oil within the asphalt shingles can seep into the ground and can cause harmful effects on the environment. However, disposing of asphalt shingles in a landfill is the typical means by which most users dispose of asphalt shingles.

Therefore, there exists a long felt need in the art for a solution that allows users to utilize asphalt shingles for construction purposes without worrying about disposal issues. There is also a long felt need in the art for a method that prevents the oil from asphalt shingles from leeching into the ground. Additionally, there is a long felt need in the art for a solution that enables users to safely dispose of asphalt shingles. Moreover, there is a long felt need in the art for a solution that ensures that the asphalt shingles do not contain oil when disposed within a landfill. Further, there is a long felt need in the art for a solution that ensures that the asphalt shingle disposal does not cause environmental harm. Furthermore, there is a long felt need in the art for a solution that allows users to use asphalt shingles for construction purposes, while easily disposing of the damaged shingles. Finally, there is a long felt need in the art for a solution that offers a safe disposal of the asphalt shingles and other housing materials.

The subject matter disclosed and claimed herein, in one embodiment thereof, comprises an asphalt shingle breakdown chemical solution. The asphalt shingle breakdown chemical solution comprises a composition of approximately 48% water by weight, 48% gasoline by weight, 2% alcohol by weight, 1.5% citrus by weight and 0.5% enzyme by weight. The chemical is in liquid form and can be applied over the shingles for removing oil from the asphalt shingles. This chemical composition offers an easy solution for safely disposing of shingles and other housing materials.

In this manner, the novel asphalt shingle breakdown chemical of the present invention accomplishes all of the forgoing objectives, and provides a relatively safe, easy and convenient solution to disposing of asphalt shingles and other housing materials. The asphalt shingle breakdown chemical solution of the present invention helps in the removal of oil products, fiberglass and granules from asphalt shingles and ensures that the asphalt shingles are safely disposed of within a landfill, without causing environmental harm.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an asphalt shingle breakdown chemical solution. The asphalt shingle breakdown chemical solution comprises a composition of approximately 48% water by weight, 48% gasoline by weight, 2% alcohol by weight, 1.5% citrus by weight and 0.5% enzyme by weight. The chemical composition is typically provided in liquid form, and can be applied over the shingles for removing oil from the asphalt shingles.

In yet another embodiment of the present invention, a chemical composition for extracting chemical oil products, fiberglass and granules from asphalt shingles is disclosed. The chemical composition comprises a composition of approximately 48% water by weight, 48% diesel by weight, 2% ethanol by weight, 1.5% citrus by weight and 0.5% enzyme by weight.

In yet another embodiment of the present invention, a method for removing oil products, fiberglass and granules from asphalt shingles, by using an asphalt shingle breakdown liquid chemical solution is described. The method comprises initially shredding the asphalt shingles by passing the asphalt shingles through a shredder machine, and submerging the shredded asphalt shingles into the asphalt shingle breakdown liquid chemical solution via a mash tank, wherein the chemical solution is received from a chemical tank and consists essentially of 48% water by weight, 48% gasoline by weight, 2% alcohol by weight, 1.5% citrus by weight and 0.5% enzyme by weight. A user then applies heat to the mash tank to allow for the chemical breakdown of any binding agents within the oil products of the asphalt shingles to create a mash, then pumps the mash through a cooker under controlled heat and pressure to allow for the chemical breakdown of the asphalt shingles, removes the gasoline and alcohol via thermostat valves of the cooker and thereafter pumps the resultant mash from the cooker to a settling tank, wherein a physical separation of said oil products takes place. Specifically, the oil products rise to the top, fiberglass and granules fall to the bottom and the enzymes float at the top with the oil products to prevent further breakdown. A user then skims off the oil products floating at the top of the settling tank, transfers the skimmed oil product into a final product tank, transfers the water, the citrus, and the left-over enzymes back into the chemical tank for re-use and finally dries and separates the granules and the fiberglass from the bottom of the settling tank for landfilling.

In yet another embodiment of the present invention, the method for removing oil products from asphalt shingles by using an asphalt shingle breakdown liquid chemical solution is a closed-loop process. Specifically, the asphalt shingle breakdown liquid chemical solution is stored in a chemical tank and the left-over water, citrus and enzymes are fed back into the chemical tank for completing the closed-loop process.

In yet another embodiment of the present invention, the asphalt shingles are shredded down to sizes approximately between a quarter and a half-dollar size. The size increases the cumulative (or total) surface area, and allows for the increased absorption and penetration of the asphalt shingle breakdown liquid chemical solution into the shredded asphalt shingles.

In yet another embodiment of the present invention, the water and the citrus of the solution cleanses the fiberglass and the granules at the bottom of the settling tank. Then, the enzymes float to the top with the oil, and stop the continual breakdown of oil products. In yet another embodiment of the present invention, the closed-loop process safely, significantly and drastically reduces the time required to remove oil products, fiberglass and granules from the asphalt shingles.

In yet another embodiment of the present invention, a system for removing oil products and separating fiberglass and granules from asphalt shingles is disclosed. The system comprises a plurality of tanks interconnected together, so as to create a closed-loop process which removes oil products, and separates fiberglass and granules from asphalt shingles using an asphalt shingle breakdown liquid chemical solution. The system further includes a shredder to shred the asphalt shingles, a mash tank to form a mash of the shingle components with the asphalt shingle breakdown liquid chemical solution, a cooker to process the mash under a controlled temperature and pressure, a settling tank for physically separating the oil, fiberglass and granules and a packaging unit to package the fiberglass and granules. Further, the ingredients of the asphalt shingle breakdown liquid chemical solution are fed back to a chemical tank for reuse, which provides a closed loop process for processing the asphalt shingles.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed, and are intended to include all such aspects and their equivalents. Other advantages and novel features will become apparent from the following detailed description, when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a block diagram showing the essential components of the asphalt shingle breakdown chemical solution of the present invention;

FIG. 2 illustrates a schematic view of one embodiment of a system of processing the asphalt shingles to remove oil products and segregate fiberglass and granules using the asphalt shingle breakdown chemical solution of the present invention in accordance with the disclosed architecture; and

FIG. 3 illustrates a flow diagram showing the essential steps for performing a closed loop process of removing and separating oil products, fiberglass and granules from asphalt shingles, using the asphalt shingle breakdown liquid chemical solution of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention, and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a solution that allows users to use asphalt shingles for construction purposes without worrying about a safe disposal. There is also a long felt need in the art for a method that prevents the oil from asphalt shingles from leeching into the ground when the shingles are disposed of within a landfill. Additionally, there is a long felt need in the art for a solution that enables users to safely dispose of asphalt shingles. Moreover, there is a long felt need in the art for a solution that ensures that asphalt shingles do not contain oil when disposed of within a landfill. Further, there is a long felt need in the art for a solution that ensures that asphalt shingle disposal does not cause environmental harm. Furthermore, there is a long felt need in the art for a solution that allows users to use asphalt shingles for construction purposes, while easily disposing of the damaged shingles. Finally, there is a long felt need in the art for a solution that offers safe disposal of asphalt shingles and other housing materials.

The present invention, in one exemplary embodiment, is a novel chemical composition for extracting chemical oil products, fiberglass and granules from asphalt shingles. The chemical composition comprises a composition of 48% water by weight, 48% diesel by weight, 2% ethanol by weight, 1.5% citrus by weight and 0.5% enzyme by weight. The chemical composition aids in the removal of oil products, fiberglass and granules from asphalt shingles, and ensures that the asphalt shingles are safely disposed of within a landfill, without causing environmental harm.

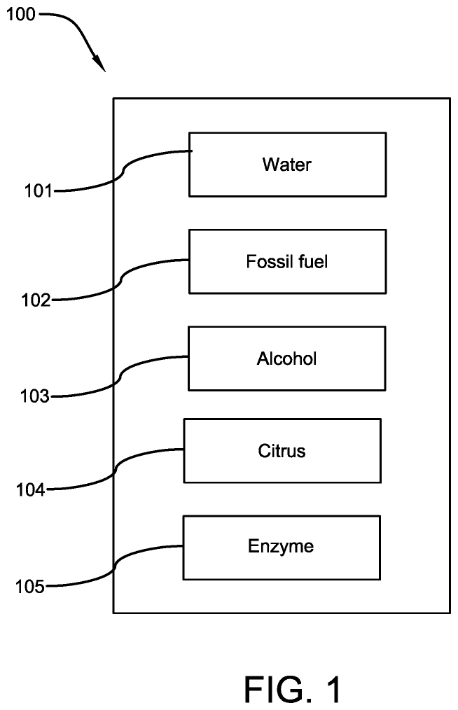

Referring initially to the drawings, FIG. 1 illustrates a block diagram showing the essential components of the asphalt shingle breakdown chemical solution of the present invention. The asphalt shingle breakdown chemical solution 100, also referred to as TranSaul in the present disclosure, is a liquid chemical composition and is used for separating and removing oil products, fiberglass and granules from asphalt shingles to create a safe product for landfill disposal. Further, the asphalt shingle breakdown chemical solution 100 provides a safe disposable by-product for the environment, and for ground water as the oil is removed from the shingles.

The asphalt shingle breakdown chemical solution 100 comprises water 101, which can be distilled water, alkaline water or mineral water, etc., or any other suitable kind of water as is known in the art. The water 101 functions as a medium and provides the aqueous nature needed for the chemical composition, thereby allowing easy absorption by the asphalt shingles. The water 101 is also used for cleaning the fiberglass component of the shingles.

The asphalt shingle breakdown chemical solution 100 also comprises a fossil fuel 102 in the form of gasoline or diesel, or any other suitable fossil fuel as is known in the art. Generally, both gasoline and diesel fuel are equally effective, and either can be used in the chemical solution 100. The fossil fuel 102 helps in breaking down the oil components of the asphalt shingles, which then allows the oil to be removed from the shingles.

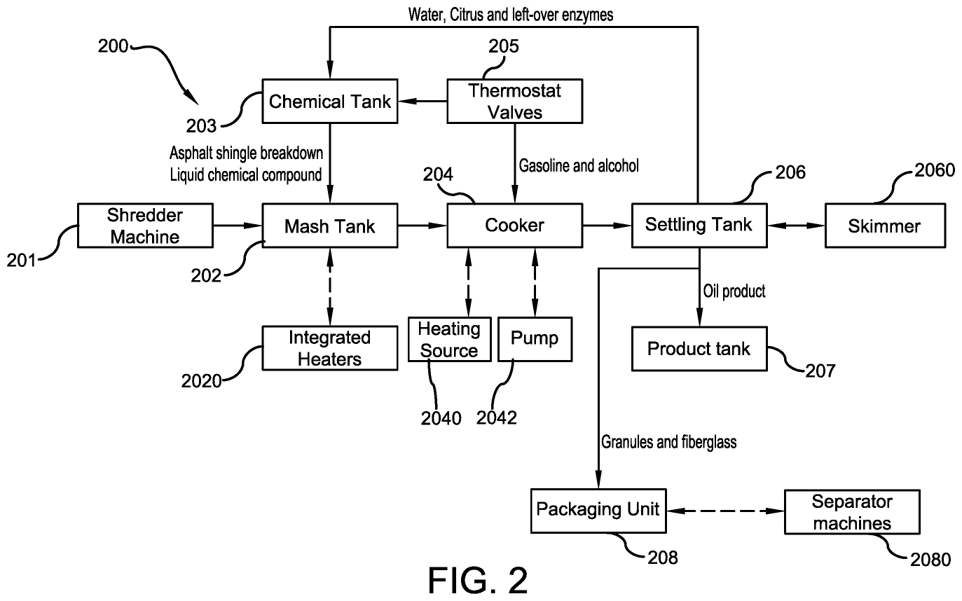

The asphalt shingle breakdown chemical solution 100 also comprises an alcohol 103 that acts as a solvent. Preferably, the alcohol is ethanol, but any other suitable alcohol known in the art can be used in the chemical solution 100, which allows a fine mash to be created as described best in FIG. 2.

The asphalt shingle breakdown chemical solution 100 comprises citrus 104, which is used for cleaning the granules of the asphalt shingles and for breaking down the oil components. Further, the citrus 104 can be any suitable synthetic or organic citrus element known in the art.

An enzyme 105 is used for stabilizing the oil present in the asphalt shingles, and prevents further breakdown of the oils. The enzyme allows the oil to be easily skimmed off the top for removal from the asphalt, and allows the segregation of the fiberglass and granules for final packaging. The enzyme 105 can be a petroleum-based enzyme that floats on water, or any other suitable enzyme as is known in the art.

Referring to Table 1, herein disclosing the asphalt shingle breakdown chemical solution 100 comprising a plurality of ingredients in varying quantities in order to achieve the desired result of removing oil products and segregating fiberglass and granules from the asphalt shingles.

TABLE 1

| | Composition in |
|---|---|
| | percentage by |
| Ingredient | weight (% w/w) |
| Water | 48 |
| Fossil Fuel | 48 |
| (Gasoline or Diesel) | |
| Alcohol | 2 |
| Citrus | 1.5 |
| Enzyme | 0.5 |

Notwithstanding, it is contemplated that the amount of water can vary between 40-50% of the composition by weight, the amount of fossil fuel can vary between 40-50% of the composition by weight, the amount of alcohol can vary between 1-5% of the composition by weight, the amount of citrus can vary between 1-5% of the composition by weight and the amount of enzyme can vary between 1-5% of the composition by weight.

FIG. 2 illustrates a schematic view of one embodiment of a system for processing the asphalt shingles to remove oil products and segregate fiberglass and granules using the asphalt shingle breakdown chemical solution of the present invention. The system 200 comprises a plurality of interconnected components that provide a closed-loop process for removing oil products and segregating fiberglass and granules safely and efficiently, while also allowing the reuse of residual ingredients of the asphalt shingle breakdown chemical solution. Further, the system 200 is fully automated and is conducted in a controlled environment, wherein heat and pressure are regulated.

Initially, a shredder machine 201 breaks down the asphalt shingles to sizes approximately between a quarter and a half-dollar size, or any other suitable size as is known in the art. The shredder machine 201 is configured to shred the asphalt shingles to the desired size, based on the needs and/or wants of a user. The shredded asphalt shingles increase the total surface area of the shingles, which allows an increased penetration of the asphalt shingle breakdown chemical solution within the shredded asphalt shingles. The shredder machine 201 comprises at least one solid and durable blade to shred the asphalt shingles. After the asphalt shingles are shredded by the shredder machine 201, the shredded shingles are transferred into a mash tank 202. Specifically, the mash tank 202 receives the asphalt shingle breakdown chemical solution from a chemical tank 203, and the shredded asphalt shingles from the shredder machine 201. The shredded asphalt shingles are submerged in TranSaul (the asphalt shingle breakdown chemical solution), and are subjected to a controlled heat environment using the integrated heaters 2020. Specifically, as heat is applied to the submerged shingles, the chemical breakdown of the binding agents within the oil products of the asphalt shingles begins, and a mash is created. The mash is then transferred from the mash tank 202 to a cooker 204 in real-time.

The cooker 204 comprises an integrated heating source 2040 and a pump 2042 for providing a controlled heat temperature and pressure within the cooker 204. This controlled heat and pressure environment allows for the rapid breakdown of the asphalt shingles into its components. Further, in the cooker 204, as the controlled temperature and pressure environment is maintained, the gasoline/diesel and alcohol ingredients from the TranSaul (chemical solution) are separated and ejected (or removed) from the cooker 204 through a pair of thermostat valves 205. The pair of thermostat valves 205 are connected to the cooker 204 and set to the desired temperature, based on the kind and amount of gasoline and/or alcohol within the chemical solution. The gasoline/diesel and alcohol that is removed from the mash through the thermostat valves 205 is then transferred back to the chemical tank 203 to form a continuous feedback loop from the cooker 204 to the chemical tank 203, allowing the residual ingredients to be re-used. Additionally, the gasoline and/or alcohol can be fed back to the chemical tank 203 in real-time or at the end of the processing cycle for the asphalt shingles, depending on the needs and/or wants of a user.

Once the gasoline and/or alcohol is removed from the mash within the cooker 204, the resulting mash (without the gasoline/diesel and alcohol) is then transferred to a settling tank 206. The mash is then allowed to settle in the settling tank 206, which allows the shingle components to physically separate from each other. Specifically, the oil products within the shingles float to the top surface, along with the enzyme from the TranSaul (chemical solution). The enzyme prevents the further breakdown of oil products from the shingles, and also stabilizes the remaining oil products. Further, the fiberglass and granule components of the shingles settle to the bottom of the mash in the settling tank 206. Finally, the water and citrus components of the TranSaul (chemical solution) cleanse the fiberglass and granule components, removing any impurities, dirt or debris that may be associated with the fiberglass and granule components.

Once the mash completely settles in the settling tank 206, the oil products are skimmed off the top by a skimmer 2060, and transferred to a product tank 207. As the oil products are removed, the oil does not get disposed of in a landfill, and the environment and ground water remain protected. The water, citrus and left-over enzymes from the mash are then fed back into the original TranSaul chemical tank 203 for reprocessing, thus completing the closed-loop process.

The remaining granules and fiberglass is then transferred to a packaging unit 208 and packaged separately for disposal. Before packaging the granules, both the granules and the fiberglass are separated using separator machines 2080. The separator machines 2080 separate the granules and fiberglass based on different sizes and shapes, and based on the needs and/or the wants of a user. Typically, the separator machines 2080 are disposed within the packaging unit 208 that packages the granules and fiberglass components separately. After packaging, the process 200 is complete, and the residual components are re-entered into the closed-loop system for reprocessing.

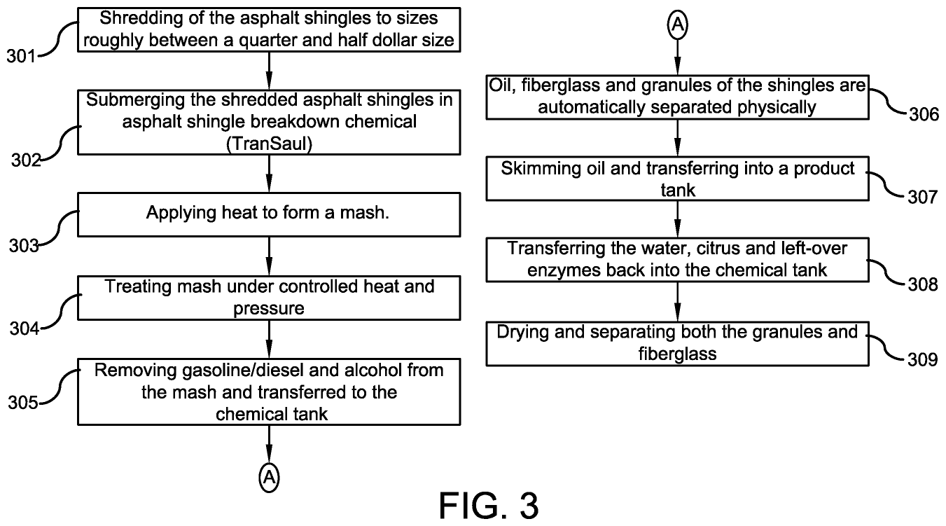

FIG. 3 illustrates a flow diagram showing the steps performed in a closed-loop process of removing and separating oil products, fiberglass and granules from asphalt shingles using the asphalt shingle breakdown liquid chemical solution of the present invention. Initially, at step 301, the asphalt shingles are shredded to sizes approximately between a quarter and a half-dollar size equivalent. The quarter and half-dollar sizes increase the total surface area and absorption rate of the asphalt shingles with the TranSaul (asphalt shingle breakdown liquid chemical solution). Then, at step 302, the shredded asphalt shingles are submerged in TranSaul (chemical solution), wherein the TranSaul is received from a source chemical tank. At step 303, the submerged shredded asphalt shingles are then heated to a controlled temperature, to begin the chemical breakdown of the binding agents within the oil products of the asphalt shingles and to form a mash. Then, at step 304, the mash is treated under a controlled heat and pressure environment that accelerates the process of removing oil products from the shingles. Thereafter, at step 305, gasoline/diesel and/or alcohol is automatically removed from the mash and returned to the chemical tank containing the TranSaul (chemical solution). At step 306, the oil, fiberglass and granule components of the shingles are automatically physically separated using their different densities. Specifically, the oil products float to the top, whereas the fiberglass and granule components settle to the bottom. At step 307, the oil products are skimmed from the top and transferred to a product tank. At step 308, the water, citrus and left-over enzymes are transferred back to the chemical tank with the TranSaul (chemical solution) to be reprocessed in further cycles of removing oil products from shingles, thus creating a closed-loop process. Finally at step 309, both the granules and the fiberglass components are separated and dried for packaging.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “asphalt shingle breakdown chemical solution”, “TranSaul”, “chemical solution” and “asphalt shingle breakdown liquid chemical solution” are interchangeable and refer to the asphalt shingle breakdown chemical solution 100 of the present invention.

Notwithstanding the forgoing, the asphalt shingle breakdown chemical solution 100 of the present invention can contain any additional or similar ingredients or compositions known in the art without affecting the overall concept of the invention, provided that it accomplishes the above-stated objectives. One of ordinary skill in the art will appreciate that the ingredients and compositions of the asphalt shingle breakdown chemical solution 100 as shown in FIGS. 1-3 is for illustrative purposes only, and that many other compositions are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations that fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An asphalt shingle breakdown chemical solution that aids in the removal of oil products, fiberglass and granules from asphalt shingles, the asphalt shingle breakdown chemical solution comprising a composition of:
a water comprising between 40-50% of the composition by weight;
a fossil fuel comprising between 40-50% of the composition by weight;
an alcohol comprising between 1-5% of the composition by weight;
a citrus comprising between 1-5% of the composition by weight; and
an enzyme comprising between 1-5% of the composition by weight.

2. The asphalt shingle breakdown chemical solution of claim 1, wherein the water is a distilled water, an alkaline water or a mineral water.

3. The asphalt shingle breakdown chemical solution of claim 1, wherein the fossil fuel is a gasoline or a diesel.

4. The asphalt shingle breakdown chemical solution of claim 1, wherein the alcohol is an ethanol.

5. The asphalt shingle breakdown chemical solution of claim 1, wherein the citrus is a synthetic citrus element.

6. The asphalt shingle breakdown chemical solution of claim 1, wherein the enzyme is a petroleum-based enzyme.

7. The asphalt shingle breakdown chemical solution of claim 1, wherein the water is 48% of the composition by weight, wherein the fossil fuel is 48% of the composition by weight, wherein the alcohol is 2% of the composition by weight, wherein the citrus is 1.5% of the composition by weight, and wherein the enzyme is 0.5% of the composition by weight.

8. A system for removing oil products and segregating fiberglass and granules safely and efficiently from a plurality of asphalt shingles, the system comprising:
a shredder machine for physically shredding the plurality of asphalt shingles;
a mash tank that receives an asphalt breakdown chemical solution from a chemical tank and shredded plurality of asphalt shingles from the shredder machine to create a mash;
a cooker that accepts the mash from the mash tank and provides a controlled heat and pressure environment for the mash;
a pair of thermostat valves connected to the cooker for removing an alcohol and a gasoline from the mash;
a settling tank for receiving the mash without the alcohol and the gasoline, and allowing a remaining shingle components to physically separate from one other, such that an oil within the plurality of asphalt shingles floats to a top surface of the mash along with an enzyme, and a plurality of fiberglass and granule components settle to a bottom of the settling tank;
a skimmer for skimming the oil off the top surface of the mash and transferring the oil to a product tank; and
a packaging unit for transferring the plurality of fiberglass and granule components for packaging.

9. The system of claim 8 further comprising a plurality of interconnected components that create a closed loop process.

10. The system of claim 9, wherein the shredder machine shreds the plurality of asphalt shingles to a particle sizes between a quarter and a half-dollar size.

11. The system of claim 10, wherein the shredded plurality of asphalt shingles are submerged in the asphalt breakdown chemical solution.

12. The system of claim 11, wherein the submerged shredded plurality of asphalt shingles are subjected to a controlled heat environment via at least one integrated heater.

13. The system of claim 12, wherein the cooker comprises a heat source and a pump for providing the controlled heat and pressure environment.

14. The system of claim 13, wherein the gasoline and the alcohol are separated and ejected from the cooker via the pair of thermostat valves which transfers the gasoline and the alcohol to a chemical tank to form a continuous loop.

15. The system of claim 14, wherein the enzyme stabilizes the oil and prevents its further breakdown.

16. The system of claim 15, wherein a water and a citrus component cleanse the plurality of fiberglass and granule components.

17. The system of claim 16, wherein the water, the citrus component and the enzyme are fed back into the chemical tank to form a continuous loop.

18. The system of claim 17, wherein the plurality of fiberglass and granule components are separated based on size using a separator machines.

19. The system of claim 18, wherein the separator machine is disposed within the packaging unit.

20. A method of removing and separating a plurality of oil product, fiberglass and granules from a plurality of asphalt shingles using an asphalt shingle breakdown chemical solution, the method comprising the steps of:
shredding the plurality of asphalt shingles to a size between a quarter and a half dollar size equivalent;
submerging the shredded plurality of asphalt shingles in the asphalt shingle breakdown chemical solution;
heating the submerged and shredded plurality of asphalt shingles into a mash;
treating the mash under a controlled heat and pressure environment;
removing any gasoline, diesel or alcohol from the mash and transferring the same to a chemical tank;
separating the plurality of oil product, fiberglass and granules within the mash;
skimming the oil product from a top surface of the mash and transferring the skimmed oil product to a product tank;
transferring a water, citrus and left-over enzyme back to the chemical tank; and
drying and separating both the fiberglass and granules for packaging.
